(19) United States
(12) Patent Application Publication
(10) Pub. No.: US 2022/0266713 A1
(43) Pub. Date: Aug. 25, 2022

(54) APPARATUSES FOR ELECTRICALLY CONNECTING ENERGY SYSTEMS

(71) Applicant: FreeWire Technologies, Inc., San Leandro, CA (US)

(72) Inventors: Alihan ASLAN, Berkeley, CA (US); Forrest NORTH, Redwood City, CA (US); Arcady SOSINOV, San Francisco, CA (US); Vishal VASMATE, San Leandro, CA (US)

(73) Assignee: FreeWire Technologies, Inc., San Leandro, CA (US)

(21) Appl. No.: 17/567,814

(22) Filed: Jan. 3, 2022

Related U.S. Application Data
(60) Provisional application No. 63/133,211, filed on Dec. 31, 2020.

(51) Int. Cl. B60L 58/10; B60L 50/60; H01M 50/517

(52) U.S. Cl. CPC B60L 58/10; B60L 50/60; H01M 50/517; B60L 50/71

(57) ABSTRACT

One aspect of the present invention pertains to an apparatus for electric energy, storage, control, and use. Another aspect of the present invention pertains to a system for electric energy, storage, control, and use.

### CROSS-REFERENCE TO RELATED APPLICATIONS

The present application claims benefit of U.S. Patent Application Ser. 63/133,211 entitled “APPARATUSES AND SYSTEMS FOR ELECTRICAL CONNECTING ENERGY STORAGE,” to Alihan ASLAN, Forrest NORTH, Arcady SOSINOV, and Vishal VASMATE, filed Dec. 31, 2020. The content of U.S. Provisional Patent application Ser. No. 61/977,493, entitled “SYSTEMS, APPARATUS, METHODS OF BATTERY CHARGING USING A MOBILE CHARGER,” to Arcady SOSINOV, Sanat KAMAL BAHL, Love KOTHARI, and Sameer MEHDIRATTA, filed Apr. 9, 2014 and U.S. Nonprovisional patent application Ser. No. 14/681,415, entitled “SYSTEMS, APPARATUS, AND METHODS OF CHARGING ELECTRIC VEHICLES” to Arcady SOSINOV, Sanat KAMAL BAHL, Love KOTHARI, and Sameer MEHDIRATTA, filed Apr. 8, 2015 is incorporated herein in its entirety by this reference for all purposes.

### BACKGROUND

The expansion of the use of electrically powered equipment is expected to continue. Associated with that expansion are issues of manufacturability, economics, and safety which are particularly challenging for applications such as energy storage systems for electric vehicles. The present inventors have developed one or more solutions that may address one or more problems related to storage, control, and use of electrical energy such as for providing electric power.

### SUMMARY

One aspect of the present invention pertains to an apparatus for electric energy, storage, control, and use. Another aspect of the present invention pertains to a system for electric energy storage, control, and use such as for providing power to electric devices and such as for charging electric energy storage devices such as batteries such as for electric devices.

It is to be understood that the invention is not limited in its application to the details of construction and to the arrangements of the components set forth in the following description. The invention is capable of other embodiments and of being practiced and carried out in various ways. In addition, it is to be understood that the phraseology and terminology employed herein are for the purpose of description and should not be regarded as limiting.

### BRIEF DESCRIPTION OF THE DRAWINGS

FIG. 1 is a box diagram according to one or more embodiments of the present invention.

FIG. 2 is a diagram according to one or more embodiments of the present invention.

FIG. 3 is a diagram according to one or more embodiments of the present invention.

FIG. 4 is a diagram according to one or more embodiments of the present invention.

FIG. 5 is a diagram according to one or more embodiments of the present invention.

Skilled artisans appreciate that elements in the figures are illustrated for simplicity and clarity and have not necessarily been drawn to scale. For example, the dimensions of some of the elements in the figures may be exaggerated relative to other elements to help to improve understanding embodiments of the present invention.

### DESCRIPTION

In the following description of the figures, identical reference numerals have been used when designating substantially identical elements or processes that are common to the figures.

Unless otherwise defined, all technical and scientific terms used herein have the same meaning as commonly understood by one of ordinary skill in the art to which this invention belongs. In case of conflict with publications, patent applications, patents, and other references mentioned incorporated herein by reference, the present specification, including definitions, will control.

Various embodiments the present invention may include any of the described features, alone or in combination. Other features and/or benefits of this disclosure will be apparent from the following description.

For the following defined terms, these definitions shall be applied, unless a different definition is given in the claims or elsewhere in this specification.

“Autonomous” is defined herein as meaning capable of operating without direct real-time control by a person(s) or operating without direct real-time control by a person(s).
“Drive battery” is defined herein as meaning a battery that provides power for propelling an electric vehicle.
“Fusing” is defined herein as meaning incorporating one or more fuses in a conductor line so as to provide electric current upper flow limits.
“Electric vehicle” (EV) is defined herein as meaning a vehicle for which at least some of the energy for moving the vehicle is derived from an onboard stored electric power supply such as a battery and/or a capacitor. Examples of electric vehicles include, but are not limited to, a battery electric vehicle, a capacitor electric vehicle, a hybrid electric vehicle, and a plug-in hybrid electric vehicle.
“Mobile” is defined herein as meaning capable of moving and/or being moved as in being portable and is not fixed to one position or place, but optionally may be attached by way of a releasable connection to an electric power line, a fuel line, an information transfer line, or combinations thereof.
“Motorized” is defined herein as meaning capable of self-propulsion such as having a motor, an engine, or other drive mechanism to accomplish locomotion.
“Remote control” is defined herein as meaning operating or being controlled from a distance.
“Wired” is defined herein as meaning having a solid physical connection for conveying information, data, signals, and/or energy.

All numeric values are herein defined as being modified by the term “about,” whether or not explicitly indicated. The term “about” generally refers to a range of numbers that a person of ordinary skill in the art would consider equivalent to the stated value to produce substantially the same properties, function, result, etc. A numerical range indicated by a low value and a high value is defined to include all numbers subsumed within the numerical range and all subranges subsumed within the numerical range. As an example, the range 10 to 15 includes, but is not limited to, 10, 10.1, 10.47, 11, 11.75 to 12.2, 12.5, 13 to 13.8, 14, 14.025, and 15.

The order of execution or performance of the operations or the processes in embodiments of the invention illustrated and described herein is not essential, unless otherwise specified. That is, the operations or the processes may be performed in any order, unless otherwise specified, and embodiments of the invention may include additional or fewer operations or processes than those disclosed herein. For example, it is contemplated that executing or performing a particular operation or process before, simultaneously with, contemporaneously with, or after another operation or process is within the scope of aspects of the invention.

As will be understood by a person skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as an “apparatus”, a “circuit,” a “module” or a “system.”

The following description is primarily directed towards electric energy systems for providing electric power to operate electric devices, for charging batteries of electric devices, and/or for charging drive batteries of electric vehicles, such as but not limited to electric automobiles. It is to be understood that one or more embodiments of the present invention apply to other electric vehicles such as, but not limited to, electric trucks, electric vans, electric buses, electric bikes, and electric motorcycles. It is also to be understood that embodiments of the present invention apply to providing electric power to homes and/or buildings.

The following documents are incorporated herein in their entirety by this reference for all purposes: U.S. Patent Application Ser. No. 62/111,333, United States Patent Application 20170077487, U.S. Pat. Nos. 9,545,010, and 9,147,875.

One aspect of the present invention pertains to an apparatus for electric energy, storage, control, and use. Embodiments of the apparatus may include a flexible interconnect circuit. Another aspect of the present invention pertains to a system for electric energy storage, control, and use such as for providing power to electric devices and such as for charging electric energy storage devices such as batteries and/or capacitors such as for electric devices and such as for electric vehicles.

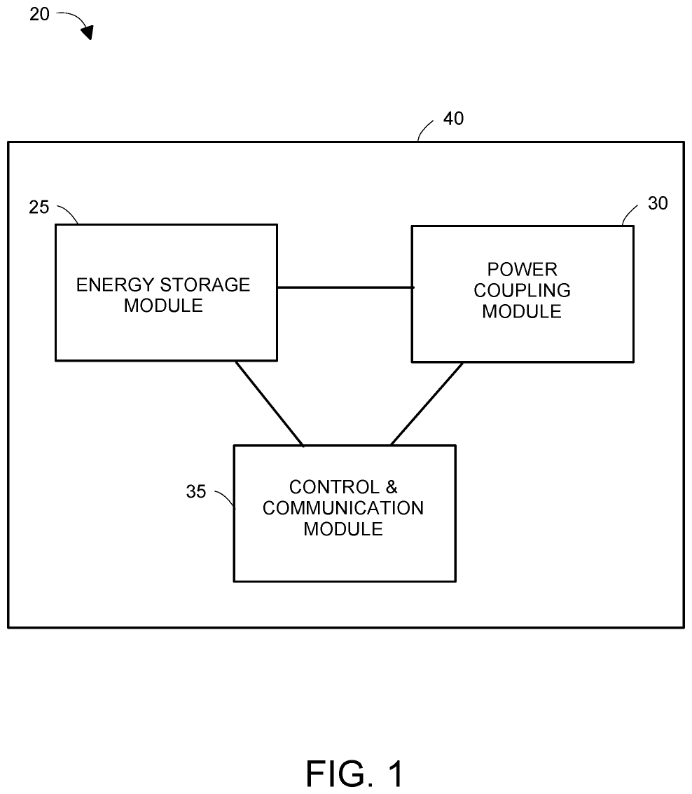

Reference is now made to FIG. 1 where there is shown a box diagram according to one or more embodiments of the present invention for an electric energy system 20. Electric energy system 20 comprises an energy module 25 comprising a plurality of energy cells (not shown in FIG. 1) having energy cell terminals, a flexible interconnect circuit comprising an electrical conductor for energy cell connection (not shown in FIG. 1) having integrated energy cell terminal contacts and power pack fuse between each energy cell. The flexible interconnect circuit is electrically connected to the energy cell terminals to collect (discharging) or distribute (charging) electric power. Electric energy system 20 also comprises a power coupling module 30 coupled to energy module 25 to accomplish input (charging) or output (discharging) of electric power. Electric energy system 20 also comprises a control and communication module 35 coupled to energy module 20 and/or the power coupling module 30. Electric energy system 20 also comprises a support module 40 to physically support energy module 25, power coupling module 30, and/or control and communication module 35.

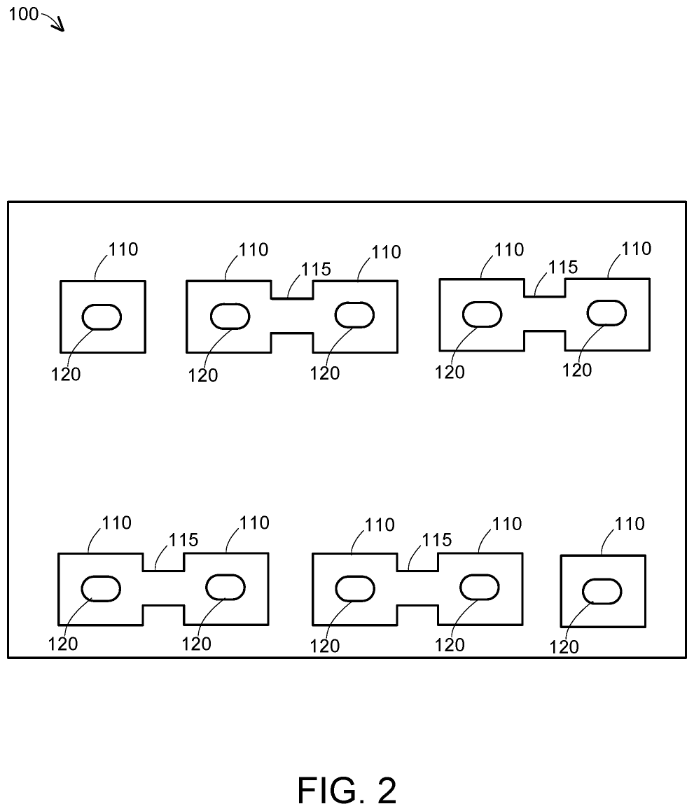

Reference is now made to FIG. 2 were there is shown a diagram of a flexible interconnect circuit 100 according to one or more embodiments of the present invention. Electric energy system 20 shown in FIG. 1 may include flexible interconnect circuit 100 shown in FIG. 2. Flexible interconnect circuit 100 circuit comprises an electrical conductor laminated with an insulator. The insulator has holes to allow electrical contacts to the electrical conductor. The electrical conductor is configured to include integrated energy cell terminal contacts 110 and power pack fusing 115 which may be disposed between each energy cell or other configuration. Flexible interconnect circuit 100 is electrically connectable to the energy cell terminals (not shown in FIG. 2) to collect (discharging) or distribute (charging) electric power.

As an option for one or more embodiments of the present invention, flexible interconnect circuit 100 has through-holes 120 disposed through energy cell terminal contacts 110 to accomplish fastening energy cell terminal contacts 110 to the energy cell terminals. As an option for one or more embodiments of the present invention, flexible interconnect circuit 100 has through-holes 120 disposed through energy cell terminal contacts 110 to accomplish fastening energy cell terminal contacts 110 to the energy cell terminals with threaded connectors. As an option for one or more embodiments of the present invention, flexible interconnect circuit 100 has through-holes 120 disposed through energy cell terminal contacts 110 to accomplish bolting energy cell terminal contacts 110 to the energy cell terminals with threaded connectors.

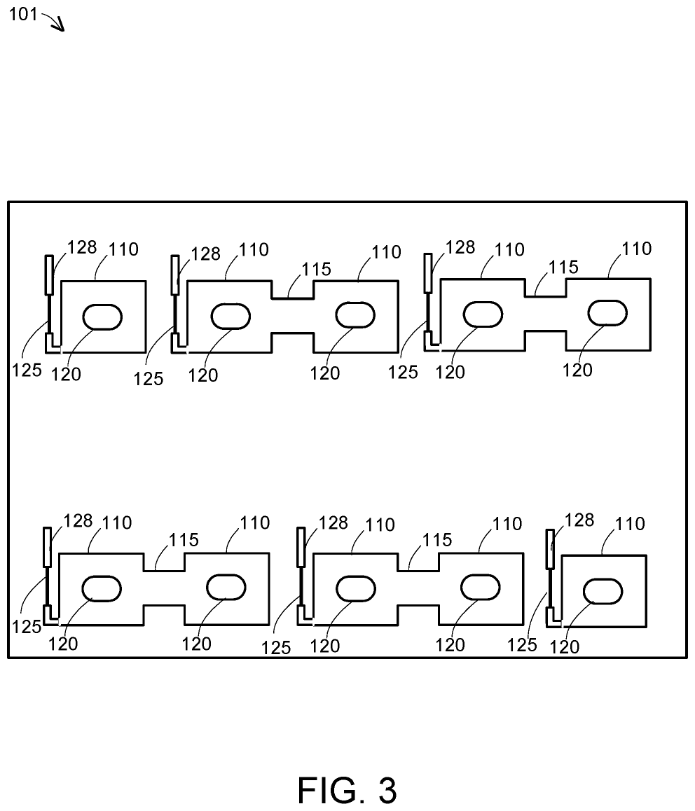

Reference is now made to FIG. 3 were there is shown a diagram of a flexible interconnect circuit 101 according to one or more embodiments of the present invention. Electric energy system 20 shown in FIG. 1 may include flexible interconnect circuit 101 shown in FIG. 3. Flexible interconnect circuit 101 is essentially the same as flexible interconnect circuit 100 with the exception of further comprising sense line fusing 125 and sense line connections 128 for sense line coupling to control and communication module 35.

According to one or more embodiments of the present invention, sense line fusing 125 and sense line connections 128 are connected to or connected proximate to power pack fuse 115 and/or the energy cell terminal contacts 110. In other words, one or more embodiments of the present invention have flexible interconnect circuit 101 configured to provide single contacts to energy cell connections and fusing between cells and sense line connections with fusing to a battery management system of the control and communication module 35, wherein the fusing between cells and the fusing to the battery management system have different current ratings. Examples of materials of construction for the fusing and details of fusing structures can be found in references such as United States Patent Application 20170077487, the contents of which are incorporated herein for all purposes.

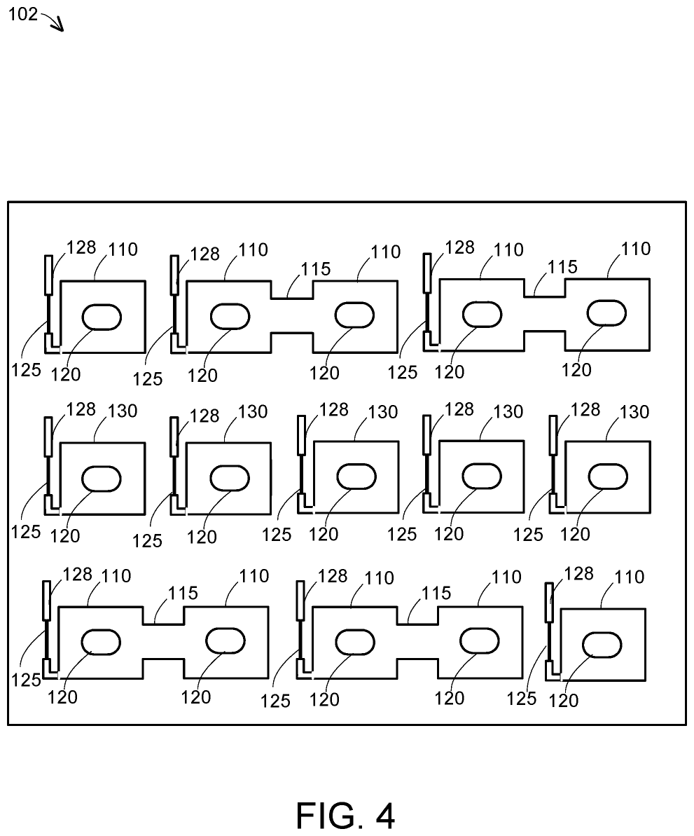

Reference is now made to FIG. 4 were there is shown a diagram of a flexible interconnect circuit 102 according to one or more embodiments of the present invention. Electric energy system 20 shown in FIG. 1 may include flexible interconnect circuit 102 shown in FIG. 4. Flexible interconnect circuit 102 is essentially the same as flexible interconnect circuit 101 with the exception of further comprising a contact for a voltage tap 130 for each energy cell. As an option for one or more embodiments of the present invention, flexible interconnect circuit 102 may further comprise sense line fusing 125 and sense line connections 128 associated with voltage tap 130.

Electric energy system 20 may include a variety of components and configurations for embodiments of the present invention. According to one or more embodiments of the present invention, the energy cells for electric energy system 20 comprise batteries. Examples of batteries suitable for embodiments of the present invention include, but are not limited to lead acid batteries, nickel cadmium batteries, nickel metal hydride batteries, lithium ion batteries, and combinations thereof. According to one or more embodiments of the present invention, the energy cells for electric energy system 20 comprises fuel cells such as hydrogen fuel cells. According to one or more embodiments of the present invention, the energy cells for electric energy system 20 comprises thermoelectric cells. According to one or more embodiments of the present invention, the energy cells for electric energy system 20 comprises photovoltaic cells. According to one or more embodiments of the present invention, the energy cells for electric energy system 20 comprises capacitors. According to one or more embodiments of the present invention, the energy cells for electric energy system 20 comprises hybrid capacitors (supercapacitors).

According to one or more embodiments of the present invention, support module 40 for electric energy system 20 comprises a motorized cart so that energy system 20 is mobile, self driven, self driven with remote control, and/or self driven with self direction. According to one or more embodiments of the present invention, support module 40 for electric energy system 20 comprises a cart so that the system is portable and/or mobile.

According to one or more embodiments of the present invention, electric energy system 20 includes hardware and software components so as to accomplish autonomous locomotion.

One or more embodiments of the present invention comprise flexible interconnect circuits such as flexible interconnect circuits 100, 101, and 102 described above for FIGS. 2, 3, and 4 for connecting electric energy cells. As an option for one or more embodiments of the present invention, flexible interconnect circuits may be wired for parallel connection of energy cells, series connection of energy cells, combinations thereof.

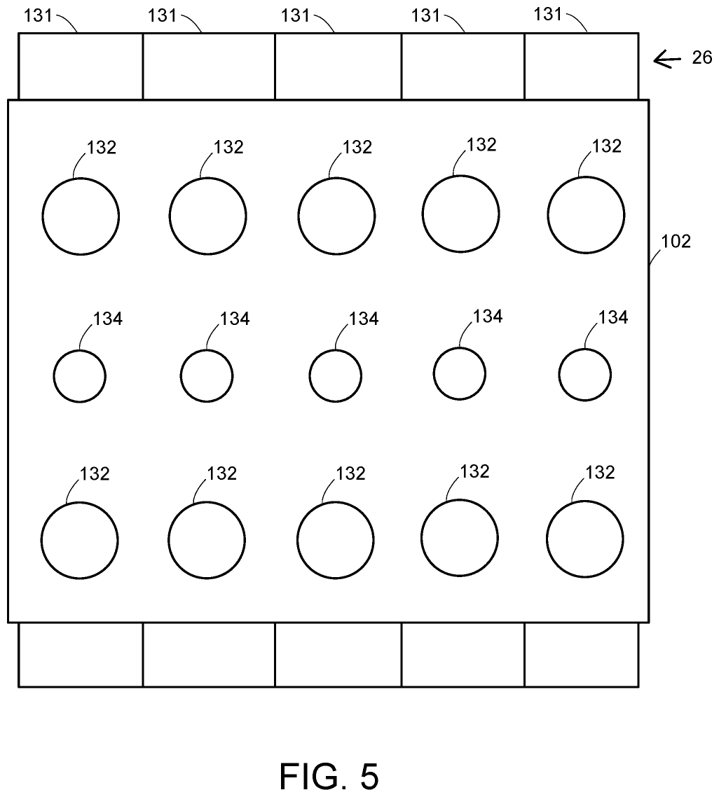

Reference is now made to FIG. 5 where there is shown a side view diagram of a flexible interconnect circuit 102 with battery cell contacts, voltage taps, and attached sense lines (wires) all of which are essentially the same as described for flexible interconnect circuit 102 in FIG. 4 mounted to an energy storage module 26 comprising a plurality of energy cells 131 such as battery cells having energy cell terminals connected with battery cell contacts. Optionally, the connections between the energy cell terminals and energy cell terminal contacts may be accomplished using a threaded connector 132 such as a screw, a bolt, or other connector. FIG. 5 also shows voltage tap connectors 134 to connect the voltage taps for energy storage cells 131 to flexible interconnect circuit 102.

As an option for one or more embodiments of the present invention, electrical conductors for the flexible interconnect circuit maybe metals and/or metal alloys comprising, but not limited to, aluminum, copper, iron, gold, nickel, silver, other metal elements, and combinations thereof. As an option for one or more embodiments of the present invention, electrical insulators for the flexible interconnect circuit may be polymers such as, but not limited to polyethylene, polyethylene terephthalate, polyester, polyimide, other polymers, and combinations thereof.

One or more aspects of the present invention comprise flexible interconnects for interconnecting a set of energy cells, assemblies comprising these interconnects, methods of forming such interconnects, and methods of forming such assemblies using the interconnects.

One or more embodiments of the present invention, includes electrical energy storage system having the energy storage module and the power coupling module configured so that they are portable, mobile, self driven, self driven with remote control, and/or self driven with self direction. Examples of configurations for one or more embodiments of the present invention include mounting or connecting the energy storage module and/or the power coupling module to a support such as, but not limited to a frame, platform, housing, wheeled cart, motorized cart, or other type of substantially rigid support to facilitate carrying, carting, and/or pulling.

For one or more embodiments of the present invention, the support module is configured as a motorized cart. When configured as a motorized cart, systems according to one or more embodiments of the present invention include a typical structure of a cart with the addition of a motor, an engine, or other drive system. More specifically, the motorized cart may include a housing, a frame, a base, and/or a platform having one or more wheels rotatably coupled thereto. The motor is coupled to the one or more wheels or treads to accomplish locomotion of the cart, i.e. movement from place to place, such as from a first location to a second location.

In the foregoing specification, the invention has been described with reference to specific embodiments; however, one of ordinary skill in the art appreciates that various modifications and changes can be made without departing from the scope of the present invention as set forth in the claims below. Accordingly, the specification is to be regarded in an illustrative, rather than a restrictive sense, and all such modifications are intended to be included within the scope of the present invention.

Benefits, other advantages, and solutions to problems have been described above with regard to specific embodiments; however, the benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” “includes,” “including,” “has,” “having,” “at least one of,” or any other variation thereof, are intended to cover a non-exclusive inclusion. For example, a process, method, article, or apparatus that comprises a list of elements is not necessarily limited only to those elements, but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

What is claimed is:

1. An electric energy system comprising:
an energy module comprising a plurality of energy cells having energy cell terminals, a flexible interconnect circuit comprising integrated energy cell terminal contacts and power pack fusing between each energy cell; the flexible interconnect circuit being electrically connected to the energy cell terminals to collect or distribute electric power;
a power coupling module coupled to the energy module to accomplish input or output of electric power;
a control and communication module coupled to the energy module and/or the power coupling module; and
a support module to physically support the energy module, the power coupling module, and/or the control and communication module.

2. The electric energy system of claim 1, wherein the flexible interconnect circuit further comprises sense line fusing and sense line connections for sense line coupling to the control and communication module.

3. The electric energy system of claim 1, wherein the flexible interconnect circuit further comprises sense line fusing and sense line connections for sense line coupling to the control and communication module; the sense line fusing being connected to or being connected proximate the power pack fuse and/or the energy cell terminal contacts.

4. The electric energy system of claim 1, wherein the flexible interconnect circuit having through-holes disposed through the energy cell terminal contacts to accomplish fastening the energy cell terminal contacts to the energy cell terminals.

5. The electric energy system of claim 1, wherein the flexible interconnect circuit having through-holes disposed through the energy cell terminal contacts to accomplish bolting the energy cell terminal contacts to the energy cell terminals with threaded connectors.

6. The electric energy system of claim 1, wherein the flexible interconnect circuit having through-holes disposed through the energy cell terminal contacts to accomplish fastening the energy cell terminal contacts to the energy cell terminals with threaded connectors.

7. The electric energy system of claim 1, wherein the flexible interconnect circuit is configured to provide single contacts to energy cell connections and fusing between cells and sense line connections with fusing to a battery management system of the control and communication module, wherein the fusing between cells and the fusing to the battery management system have different current ratings.

8. The electric energy system of claim 1, wherein the flexible interconnect circuit further comprises a voltage tap for each energy cell.

9. The electric energy system of claim 1, wherein the flexible interconnect circuit further comprises a voltage tap with fusing for each energy cell.

10. The electric energy system of claim 1, wherein the energy cells comprise batteries.

11. The electric energy system of claim 1, wherein the energy cells comprise fuel cells.

12. The electric energy system of claim 1, wherein the energy cells comprise capacitors.

13. A flexible interconnect circuit for connecting electric energy cells, the interconnect circuit comprising an electrical conductor laminated with an insulator, the electrical conductor comprising integrated energy cell terminal contacts and power pack fusing between each energy cell; the flexible interconnect circuit being electrically connectable to the energy cell terminals to collect or distribute electric power.

14. The flexible interconnect circuit of claim 13, wherein the flexible interconnect circuit further comprises sense line fusing and sense line connections for sense line coupling to a control and communication module.

15. The flexible interconnect circuit of claim 13, wherein the flexible interconnect circuit further comprises sense line fusing and sense line connections for sense line coupling to the control and communication module; the sense line fusing being connected to or being connected proximate the power pack fusing and/or the energy cell terminal contacts.

16. The flexible interconnect circuit of claim 13, wherein the flexible interconnect circuit having through-holes disposed through the energy cell terminal contacts to accomplish fastening the energy cell terminal contacts to the energy cell terminals.

17. The flexible interconnect circuit of claim 13, wherein the flexible interconnect circuit having through-holes disposed through the energy cell terminal contacts to accomplish bolting the energy cell terminal contacts to the energy cell terminals with threaded connectors.

18. The flexible interconnect circuit of claim 13, wherein the flexible interconnect circuit having through-holes disposed through the energy cell terminal contacts to accomplish fastening the energy cell terminal contacts to the energy cell terminals with threaded connectors.

19. The flexible interconnect circuit of claim 13, wherein the flexible interconnect circuit is configured to provide single contacts to energy cell connections and fusing between cells and sense line connections with fusing to a battery management system, wherein the fusing between cells and the fusing to the battery management system have different current ratings.

20. The flexible interconnect circuit of claim 13, wherein the flexible interconnect circuit further comprises a voltage tap with fusing for each energy cell.
